(19) United States
(12) Patent Application Publication
(10) Pub. No.: US 2022/0198547 A1
(43) Pub. Date: Jun. 23, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Kimihiko ISOBE, Kanagawa (JP); Takuma SUZUKI, Tokyo (JP)

(73) Assignee: FUJIFILM Business Innovation Corp., Tokyo (JP)

(21) Appl. No.: 17/335,054

(22) Filed: May 31, 2021

(30) Foreign Application Priority Data
Dec. 22, 2020 (JP) 2020-212628

(51) Int. Cl. G06Q 30/06

(52) U.S. Cl. CPC G06Q 30/0633

(57) ABSTRACT

An information processing apparatus includes a processor configured to: acquire an ordering condition for each of plural outsourcing patterns from an ordering company that places an order in a case where the ordering company outsources at least a part of the order; acquire order receiving conditions presented by plural order receiving companies that are candidates for an outsourcee; and perform control for displaying, for each of the plural outsourcing patterns, information on an order receiving company that presents an order receiving condition meeting the ordering condition for the outsourcing pattern and information on a profit which the ordering company is supposed to get when outsourcing the at least the part of the order to the order receiving company.

### CROSS-REFERENCE TO RELATED APPLICATIONS

This application is based on and claims priority under 35 USC 119 from Japanese Patent Application No. 2020-212628 filed Dec. 22, 2020.

### BACKGROUND

### (i) Technical Field

The present disclosure relates to an information processing apparatus and a non-transitory computer readable medium.

### (ii) Related Art

For example, Japanese Unexamined Patent Application Publication No. 2002-352049 describes an ordering management system in which current budget information and management budget information are linked to reflect management budget data in the current budget information and ordering management processing and cost management processing are performed in real time in construction undertaking processing. This ordering management system makes preparations for placing an order based on a working budget, considers placement of an order based on estimates from order recipients, creates a management budget for actual operation by reflecting a result of the decided order placement in the working budget, and performs cost management and performance management based on the management budget.

Japanese Unexamined Patent Application Publication No. 2002-140395 describes an estimate table for speedily and easily optimizing scheduling in a case where production of a product, service, or the like is subcontracted to hierarchical departments or outside suppliers and an order receiving/placing method which uses this estimate table. According to this order receiving/placing method, in a case where an order for production of a product or service is received from a client and at least a part of the production regarding the received order is ordered from one or plural departments including outside suppliers, a table of hourly estimates having row or column data of plural different start times and column or row data of plural different end times concerning production of the product or service and price data for each combination of a start time of the row or column data and an end time of the column or row data is created for each of the plural departments, and a table of total hourly estimates is created based on the tables of hourly estimates created for the respective plural departments and is presented to the client.

Japanese Unexamined Patent Application Publication No. 2001-319101 describes a reverse auction method using a computer that enables a successful bid between an orderer and an order recipient. This reverse auction method includes a first step in which a mediator gives a specific identification code to an orderer who desires to put something on an auction, a second step in which the orderer enters the identification code by connecting to a web screen and then writes designated items on an order request screen, and order contents checked by the mediator are posted on an auction site, and a third step in which those who want to receive the order acknowledged by the mediator in advance enters a price for receiving the order in accordance with the order contents posted on the auction site and only one who entered a price equal to or lower than a price desired by the orderer can win a bid.

### SUMMARY

There is an order receiving/placing system that controls receipt and placement of an order between an ordering company that wants to outsource at least a part of a received order and an order receiving company that is a candidate for a subcontractor.

In this order receiving/placing system, there are various patterns of outsourcing (referred to as “outsourcing patterns”) depending on situations such as a pattern in which the ordering company outsources production of a specific product included in the order, a pattern in which the ordering company outsources production of a specific component, and a pattern in which the ordering company outsources a specific production process.

However, in this order receiving/placing system, it is impossible to display plural outsourcing patterns and display, for each of the outsourcing patterns, information on a profit of the ordering company together with information on an order receiving company. Therefore, for the ordering company to grasp how much profit the ordering company is supposed to get by outsourcing an order to which order receiving company in which outsourcing pattern, it is necessary for a person in charge to individually acquire and grasp information on a profit of the ordering company for each of the outsourcing patterns. This takes time.

Aspects of non-limiting embodiments of the present disclosure relate to providing an information processing apparatus and a non-transitory computer readable medium that make it possible to grasp information on a profit of an ordering company without the need for a person in charge to individually acquire information on a profit of the ordering company for each of outsourcing patterns.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: acquire an ordering condition for each of a plurality of outsourcing patterns from an ordering company that places an order in a case where the ordering company outsources at least a part of the order; acquire order receiving conditions presented by a plurality of order receiving companies that are candidates for an outsourcee; and perform control for displaying, for each of the plurality of outsourcing patterns, information on an order receiving company that presents an order receiving condition meeting the ordering condition for the outsourcing pattern and information on a profit which the ordering company is supposed to get when outsourcing the at least the part of the order to the order receiving company.

### BRIEF DESCRIPTION OF THE DRAWINGS

An exemplary embodiment of the present disclosure will be described in detail based on the following figures, wherein:

FIG. 1 illustrates an example of a configuration of an order placing/receiving system for placing and receiving an order of a product according to an exemplary embodiment;

FIG. 2 illustrates an example of production equipment information;

FIG. 3 illustrates correspondences between an order receiving company, equipment, and supported items based on the production equipment information illustrated in FIG. 2;

FIG. 4 illustrates a configuration of a printed material in an “ORDER” received from an ordering company and an example of production processes for producing the printed material;

FIG. 5 is a view for explaining outsourcing patterns in which an ordering company outsources an order to an order receiving company according to the exemplary embodiment;

FIG. 6 is a block diagram illustrating an example of an electric configuration of an information processing apparatus according to the exemplary embodiment;

FIG. 7 is a block diagram illustrating an example of a functional configuration of the information processing apparatus according to the exemplary embodiment;

FIG. 8 is a view for explaining a method for calculating an estimated amount of money to be charged by an order receiving company presented to an ordering company according to the exemplary embodiment;

FIG. 9 is a view for explaining a method for calculating a budget of an ordering company according to the exemplary embodiment;

FIG. 10 illustrates an example of a state in which a list of order receiving companies that present order receiving conditions that meet an ordering condition including a single production requirement is displayed in a case where an outsourcing pattern of an ordering company is designated according to the present exemplary embodiment;

FIG. 11 illustrates an example of a state where a list of order receiving companies that present order receiving conditions that meet an ordering condition including plural production requirements in a case where an outsourcing pattern of an ordering company is designated according to the present exemplary embodiment;

FIG. 12 illustrates an example of comparison index values of an order receiving company presented to an ordering company according to the exemplary embodiment;

FIG. 13 illustrates an example of a state where plural outsourcing patterns are displayed in a comparable manner according to the exemplary embodiment;

FIG. 14 illustrates an example of a state where a list of order receiving companies is displayed according to the exemplary embodiment;

FIG. 15 illustrates an example of a UI screen according to the exemplary embodiment; and

FIG. 16 is a flowchart illustrating an example of a flow of processing performed by an information processing program according to the exemplary embodiment.

### DETAILED DESCRIPTION

An exemplary embodiment of the technique according to the present disclosure is described in detail below with reference to the drawings. Note that constituent elements and processes that operate, act, and function in the same ways are given identical reference signs throughout all drawings, and repeated description thereof is omitted as appropriate. Each drawing is merely schematic illustration for full understanding of the technique of the present disclosure. Therefore, the technique according to the present disclosure is not limited to the illustrated examples. In the present exemplary embodiment, description of configurations that are not directly related to the technique according to the present disclosure and known configurations may be omitted.

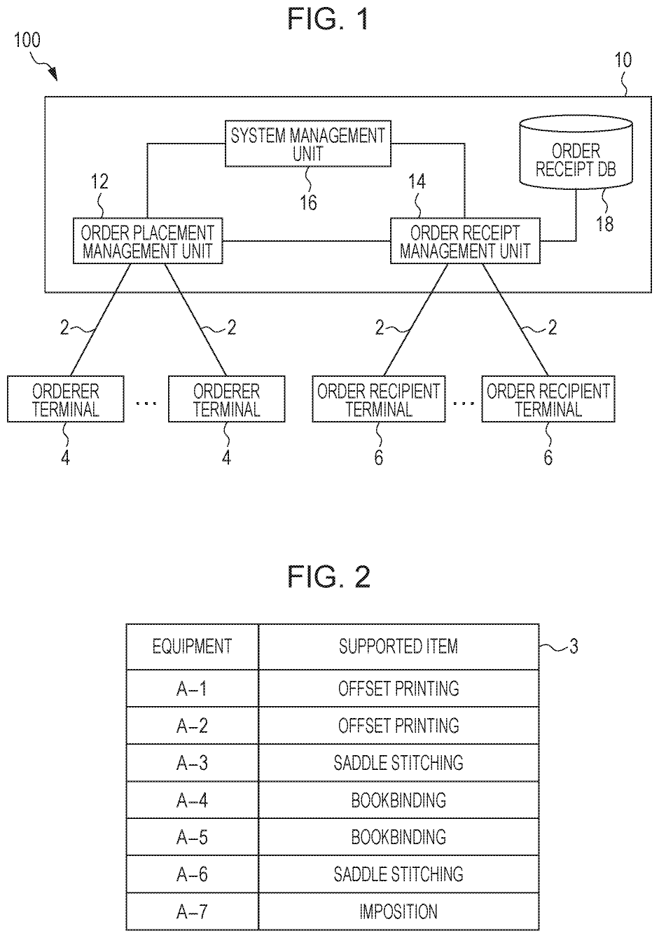

FIG. 1 illustrates an example of a configuration of an order placing/receiving system 100 for placing and receiving an order of a product according to the present exemplary embodiment.

There is no restriction on the kind of product handled in the order placing/receiving system 100 according to the present exemplary embodiment as long as production of the product starts after receipt of an order. The “product” as used herein encompasses not only a tangible object, but also an intangible object such as design data.

The following describes, as an example, a case where the order placing/receiving system 100 accepts an order for a printed material such as a book or a brochure from an ordering company and mediates between the ordering company and an order receiving company so that the printed material is produced by an order receiving company designated by the ordering company from among plural presented order receiving companies.

As illustrated in FIG. 1, the order placing/receiving system 100 includes an orderer terminal 4 provided in each ordering company, an order recipient terminal 6 provided in each order receiving company, and an information processing apparatus 10 connected to the orderer terminals 4 and the order recipient terminals 6 through a communication line 2. The communication line 2 is not limited to a specific type and may be wired or may be wireless and may be a dedicated line or may be a public line.

The information processing apparatus 10 includes, as functional units, an order placement management unit 12, an order receipt management unit 14, and a system management unit 16 and an order receipt database (DB) 18.

The order placement management unit 12 accepts an order for a printed material from each orderer terminal 4 and supplies the orderer terminal 4 with order receiving conditions on which the order is received by order receiving companies that can produce a printed material that meets request specifications designated by the order. A person in charge of the ordering company gives the order placement management unit 12 instruction information designating an order receiving company which the ordering company requests to produce the printed material from among the order receiving companies presented by the information processing apparatus 10 by referring to the order receiving conditions of the respective order receiving companies supplied to the orderer terminal 4.

The order receiving conditions supplied to the orderer terminal 4 by the order placement management unit 12 are set by the order receipt management unit 14.

Note that supplying the order receiving conditions to the orderer terminal 4 means enabling the person in charge of the ordering company to recognize the order receiving conditions through the orderer terminal 4, and examples thereof include displaying the order receiving conditions on a screen of the orderer terminal 4, giving an audio notification of the order receiving conditions, printing the order receiving conditions on paper by using an image forming apparatus, and storing the order receiving conditions in a storage device. The following discusses an example in which when the order placement management unit 12 supplies the order receiving conditions to the orderer terminal 4, the order receiving conditions are displayed on the screen of the orderer terminal 4.

The order receipt management unit 14 receives an order of the ordering company from the order placement management unit 12, acquires requested specifications of a printed material included in the order, and selects an order receiving company (referred to as a “specific order receiving company”) that can produce a printed material that meets the requested specifications from among plural order receiving companies, which are an example of candidates for an outsourcee that are registered in advance.

Then, the order receipt management unit 14 sets, for each specific order receiving company, an order receiving condition for receiving the requested order for the printed material based on registered information registered in advance in the information processing apparatus 10 by order receiving companies including the specific order receiving company and notifies the order placement management unit 12 about the order receiving condition. The registered information registered by the order receiving companies is stored in the order receipt DB 18.

The registered information registered in advance in the information processing apparatus 10 by the order receiving companies includes information for allowing the information processing apparatus 10 to select the specific order receiving company for the order of the ordering company and set the order receiving condition. Specifically, the registered information includes production equipment information 3.

FIG. 2 illustrates an example of the production equipment information 3.

As illustrated in FIG. 2, the production equipment information 3 is information on correspondences between kinds of equipment, which is an example of production apparatuses (hereinafter referred to as “production equipment”) which an order receiving company owns for production of a printed material and supported items supported by the equipment. Although FIG. 2 illustrates an example of the production equipment information 3 of a specific order receiving company (order receiving company A), the production equipment information 3 is prepared for each order receiving company.

The production equipment information 3 illustrated in FIG. 2 indicates that the order receiving company A owns seven pieces of equipment A-1 to A-7 and offset printing, saddle stitching, bookbinding, and imposition are supported. Furthermore, the production equipment information 3 illustrated in FIG. 2 indicates that the equipment A-1 and the equipment A-2 are used for offset printing, the equipment A-3 and the equipment A-6 are used for saddle stitching, the equipment A-4 and the equipment A-5 are used for bookbinding, and equipment A-7 is used for imposition.

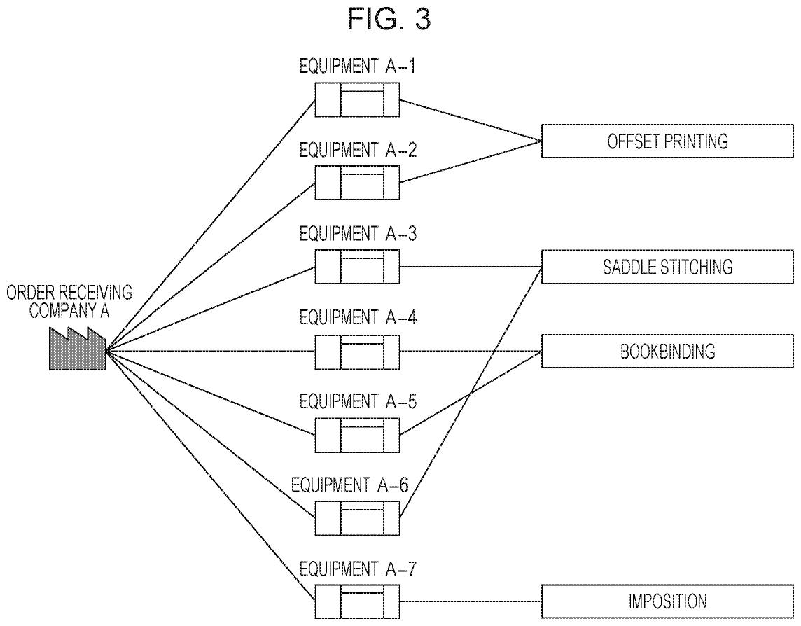

FIG. 3 illustrates correspondences among the order receiving company, equipment, and supported items based on the production equipment information 3 illustrated in FIG. 2.

When selecting a specific order receiving company from among plural order receiving companies, the order receipt management unit 14 selects a combination of an order receiving company that owns equipment that supports requested specifications designated by an order and equipment to be used by referring to the production equipment information 3. For example, in a case where requested specifications of an order designate offset printing, the order receipt management unit 14 selects combinations [order receiving company A, equipment A-1] and [order receiving company A, equipment A-2].

Needless to say, in a case where there is(are) order receiving company(s) other than the order receiving company A that own(s) equipment that supports requested specifications designated by the order, the order receipt management unit 14 selects all of the order receiving companies that own equipment that supports requested specifications designated by the order as specific order receiving companies and select combinations of a selected specific order receiving company and equipment used in the selected specific order receiving company.

The system management unit 16 of the information processing apparatus 10 illustrated in FIG. 1 controls the order placement management unit 12 and the order receipt management unit 14, and the order placement management unit 12 and the order receipt management unit 14 cooperate to perform processing for matching between an ordering company and an order receiving company.

The information processing apparatus 10 stores, for each order receiving company registered in advance, kinds of equipment which the order receiving company owns and items supported by the pieces of equipment as registered information in the order receipt DB 18. Accordingly, an order receiving condition may be set not only for each order receiving company, but also for each equipment of an order receiving company.

This means that not only a collective ordering pattern in which an ordering company requests a single order receiving company to produce a printed material, but also a distributed ordering pattern in which an ordering company requests different order receiving companies to be in charge of respective products, components, or production processes of a printed material are available.

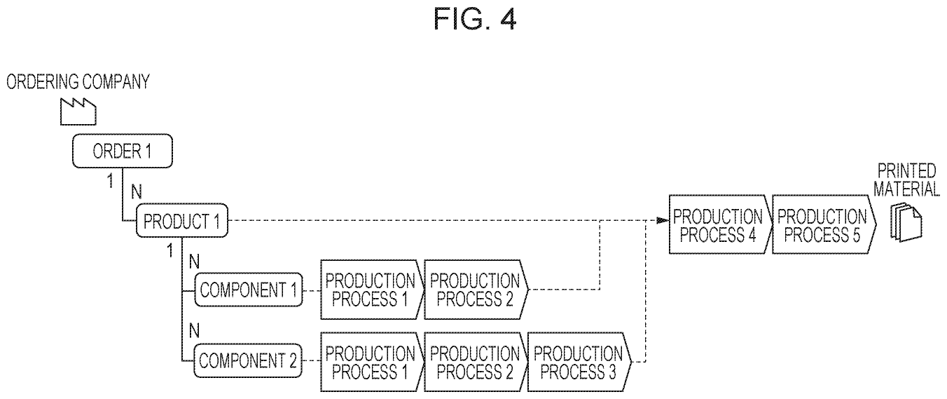

FIG. 4 illustrates a configuration of a printed material in an “ORDER” received from an ordering company and an example of production processes for producing the printed material.

In FIG. 4, the symbol “N” beside an upper left corner of a frame within which an item such as “PORODUCT 1”, “COMPONENT 1”, or “COMPONENT 2” is shown means that the number of items is at least one. Furthermore, the symbol “1” below “ORDER 1” means that “ORDER 1” is constituted by a single order.

Therefore, FIG. 4 illustrates a configuration of a printed material in which a single order includes at least one product and a single product includes at least one component. For example, in a case where a product is a book, a front cover, a body, and a belly band of a book are components of the book.

Furthermore, FIG. 4 indicates that “COMPONENT 1” is produced through “PRODUCTION PROCESS 1” and “PRODUCTION PROCESS 2” and “COMPONENT 2” is produced through “PRODUCTION PROCESS 1”, “PRODUCTION PROCESS 2”, and “PRODUCTION PROCESS 3”. FIG. 4 indicates that a printed material is produced when “COMPONENT 1” and “COMPONENT 2” are supplied to “PRODUCTION PROCESS 4” and “PRODUCTION PROCESS 4” and “PRODUCTION PROCESS 5” are executed. The “PRODUCTION PROCESS 1” to “PRODUCTION PROCESS 5” are, for example, production processes corresponding to imposition, offset printing, saddle stitching, bookbinding, and inspection, respectively.

Since the information processing apparatus 10 outputs an order receiving condition for each of pieces of equipment that are in charge of the respective production processes, a person in charge of an ordering company can, for example, order “COMPONENT 1” and “COMPONENT 2” from an order receiving company A and an order receiving company B, respectively, which are different order receiving companies, and order “PRODUCTION PROCESS 4” and subsequent processes from an order receiving company C. Furthermore, the person in charge of the ordering company can use different order receiving companies for respective production processes of a same component. For example, the person in charge of the ordering company can order “PRODUCTION PROCESS 1” and “PRODUCTION PROCESS 2” of “COMPONENT 1” from the order receiving company A and the order receiving company B, respectively.

Needless to say, in a case where there is an order receiving company that can receive an order on a component basis, product basis, or order basis, the information processing apparatus 10 can give an order to a single order receiving company collectively on a component basis, product basis, or order basis.

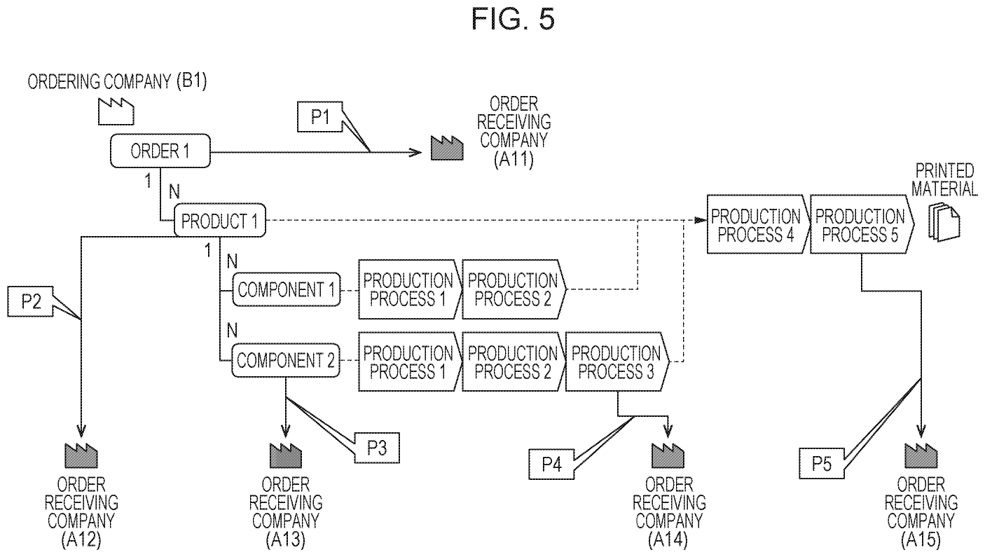

FIG. 5 is a view for explaining outsourcing patterns in which an ordering company B1 outsources an order to order receiving companies A11 to A15 according to the present exemplary embodiment.

An outsourcing pattern according to the present exemplary embodiment is a pattern of outsourcing at least a part of an order, and examples of the outsourcing pattern include a pattern in which a whole order is outsourced, a pattern in which production of a specific product, production of a component, or a production process included in an order is partially outsourced, and a pattern in which a combination of plural production processes (or production of plural products or production of plural components) included in an order is outsourced.

Specifically, outsourcing patterns P1 to P5 are illustrated in the example of FIG. 5. The outsourcing pattern P1 is a pattern in which the ordering company B1 outsources the whole order to the order receiving company A11. The outsourcing pattern P2 is a pattern in which the ordering company B1 outsources production of a specific product (e.g., “PRODUCT 1”) to the order receiving company A12. The outsourcing pattern P3 is a pattern in which the ordering company B1 outsources production of a specific component (e.g., “COMPONENT 2”) to the order receiving company A13. The outsourcing pattern P4 is a pattern in which the ordering company B1 outsources a specific number of copies (e.g., 500 copies out of 1000 copies) to the order receiving company A14. The outsourcing pattern P5 is a pattern in which the ordering company B1 outsources a specific production process (e.g., special processing) to the order receiving company A15. Note that the order receiving companies A11 to A15 may be first tier contractors, second tier subcontractors.

The ordering company B1 is an example of an ordering company that places an order (outsources an order), and the order receiving companies A11 to A15 are an example of order receiving companies that present order receiving conditions that meet an ordering condition for an outsourcing pattern.

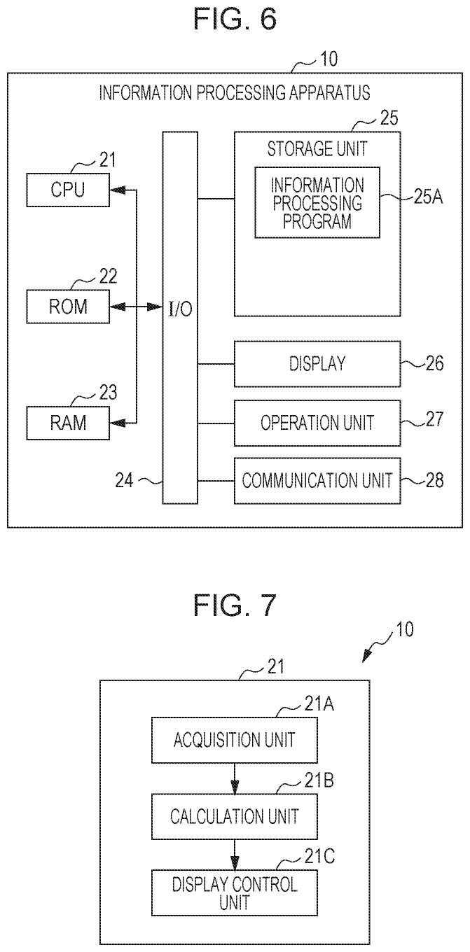

FIG. 6 is a block diagram illustrating an example of an electric configuration of the information processing apparatus 10 according to the present exemplary embodiment.

As illustrated in FIG. 6, the information processing apparatus 10 according to the present exemplary embodiment includes a central processing unit (CPU) 21, a read only memory (ROM) 22, a random access memory (RAM) 23, an input/output interface (I/O interface) 24, a storage unit 25, a display 26, an operation unit 27, and a communication unit 28.

The information processing apparatus 10 according to the present exemplary embodiment is, for example, a general-purpose computer apparatus such as a server computer or a personal computer (PC).

The CPU 21, the ROM 22, the RAM 23, and the I/O 24 are connected to one another through a bus. The I/O 24 is connected to functional units including the storage unit 25, the display 26, the operation unit 27, and the communication unit 28. The functional units can communicate with the CPU 21 through the I/O 24.

The CPU 21, the ROM 22, the RAM 23, and the I/O 24 constitute a controller. The controller may be a second controller that controls operation of a part of the information processing apparatus 10 or may be a part of a first controller that controls operation of the whole information processing apparatus 10. One, some, or all of the blocks of the controller is(are) realized by using an integrated circuit such as large scale integration (LSI) or an integrated circuit (IC) chip set. The blocks may be realized by individual circuits or a circuit on which one, some, or all of the blocks is(are) integrated may be used. The blocks may be integral with one another or one or some of the blocks may be separately provided. Furthermore, a part of each of the blocks may be separately provided. Integration of the controller is not limited to LSI, and a dedicated circuit or a general-purpose processor may also be used.

The storage unit 25 is, for example, a hard disk drive (HDD), a solid state drive (SSD), or a flash memory. The storage unit 25 stores therein an information processing program 25A according to the present exemplary embodiment. The information processing program 25A may be stored in the ROM 22.

The information processing program 25A may be, for example, installed in advance in the information processing apparatus 10. The information processing program 25A may be stored in a non-volatile recording medium or distributed over a network and be installed as appropriate in the information processing apparatus 10. Examples of the non-volatile recording medium include a compact disc read only memory (CD-ROM), a magnetic optical disc, an HDD, a Digital Versatile Disc Read Only Memory (DVD-ROM), a flash memory, and a memory card.

The display 26 is, for example, a liquid crystal display (LCD) or an organic Electro Luminescence (EL) display. The display 26 may have a touch panel in an integrated manner. The operation unit 27 has, for example, devices for operation input such a keyboard and a mouse. The display 26 and the operation unit 27 receive various instructions from a user of the information processing apparatus 10. The display 26 displays various kinds of information such as a result of processing performed in response to an instruction received from the user and a notification concerning the processing.

The communication unit 28 is, for example, connected to a communication line 2 such as the Internet, a local area network (LAN), or a wide area network (WAN) and can communicate with external devices such as the orderer terminals 4 and the order recipient terminals 6 through the communication line 2.

As described above, for an ordering company to grasp how much profit the ordering company is supposed to get by outsourcing an order to which order receiving company in which outsourcing pattern, a person in charge needs to acquire and grasp information on a profit of the ordering company individually for each outsourcing pattern, and this takes time.

The information processing apparatus 10 according to the present exemplary embodiment performs control for displaying plural outsourcing patterns for an ordering company that outsources at least a part of an order so that information on an order receiving company that is a candidate for an outsourcee and information on a profit which the ordering company is supposed to get when outsourcing the at least the part of the order to the order receiving company are displayed for each of the plural outsourcing patterns.

Specifically, the CPU 21 of the information processing apparatus 10 according to the present exemplary embodiment functions as the units illustrated in FIG. 7 by writing the information processing program 25A stored in the storage unit 25 into the RAM 23 and executing the information processing program 25A. The CPU 21 is an example of a processor.

FIG. 7 is a block diagram illustrating an example of a functional configuration of the information processing apparatus 10 according to the present exemplary embodiment.

As illustrated in FIG. 7, the CPU 21 of the information processing apparatus 10 according to the present exemplary embodiment functions as an acquisition unit 21A, a calculation unit 21B, and a display control unit 21C.

The acquisition unit 21A acquires an ordering condition for each outsourcing pattern from the orderer terminal 4 provided in an ordering company that places an order in a case where the ordering company outsources at least a part of the order. The ordering condition includes a production requirement and a budget concerning the at least the part of the order to be outsourced. The production requirement is, for example, information specifying production contents such as “printing”, “bookbinding”, “saddle stitching”, or “imposition”. The budget is, for example, expressed as an amount of money indicative of a production cost which the ordering company is supposed to bear in a case where the ordering company undertakes production. Note that the ordering condition may include information indicative of a type (e.g., offset printing, digital printing) of production equipment desired by the ordering company and may further include information indicative of a model (kind of equipment) of production equipment desired by the ordering company for each type of production equipment.

As the outsourcing patterns, all assumed outsourcing patterns according to the order may be designated by the acquisition unit 21A or assumed outsourcing patterns may be selectively designated by a person in charge of the ordering company.

Furthermore, the acquisition unit 21A acquires order receiving conditions presented by plural order receiving companies that are candidates for an outsourcee from the order receipt DB 18. The order receiving conditions include base information on a base for calculation of a production cost.

The calculation unit 21B calculates a production cost according to the production requirement and an estimated amount of money to be charged based on the production cost by using the production requirement and the base information acquired by the acquisition unit 21A and calculates information on a profit of the ordering company based on the calculated estimated amount of money and budget. The information on the profit of the ordering company is, for example, expressed as a profit rate or a profit amount relative to the budget.

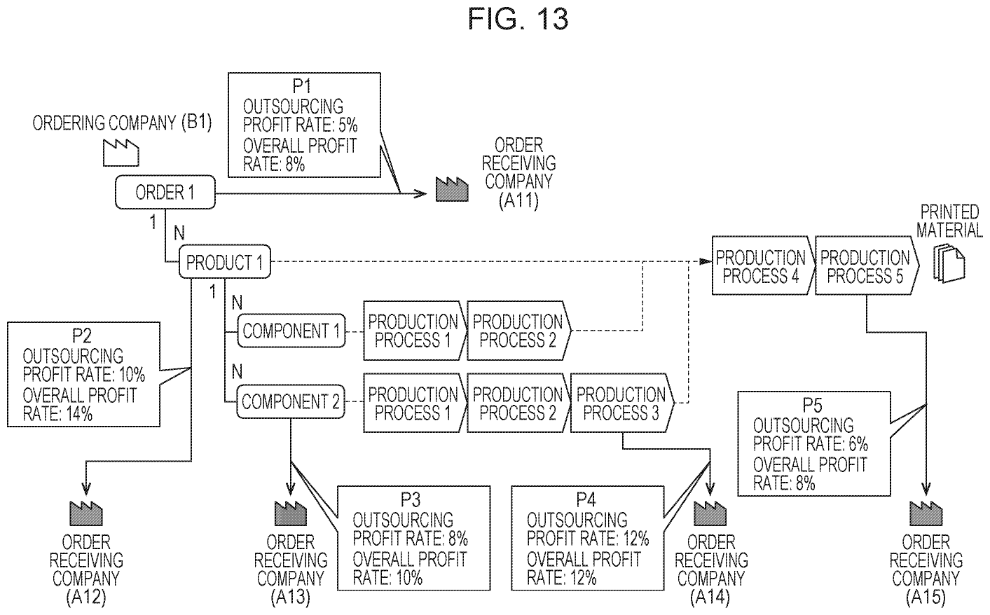

The display control unit 21C performs control for displaying, for each of plural outsourcing patterns, information indicative of an order receiving company that presents an order receiving condition that meets an ordering condition for the outsourcing pattern and displaying information on a profit which the ordering company is supposed to get when outsourcing an order to the order receiving company on the orderer terminal 4, for example, as illustrated in FIG. 13, which will be described later.

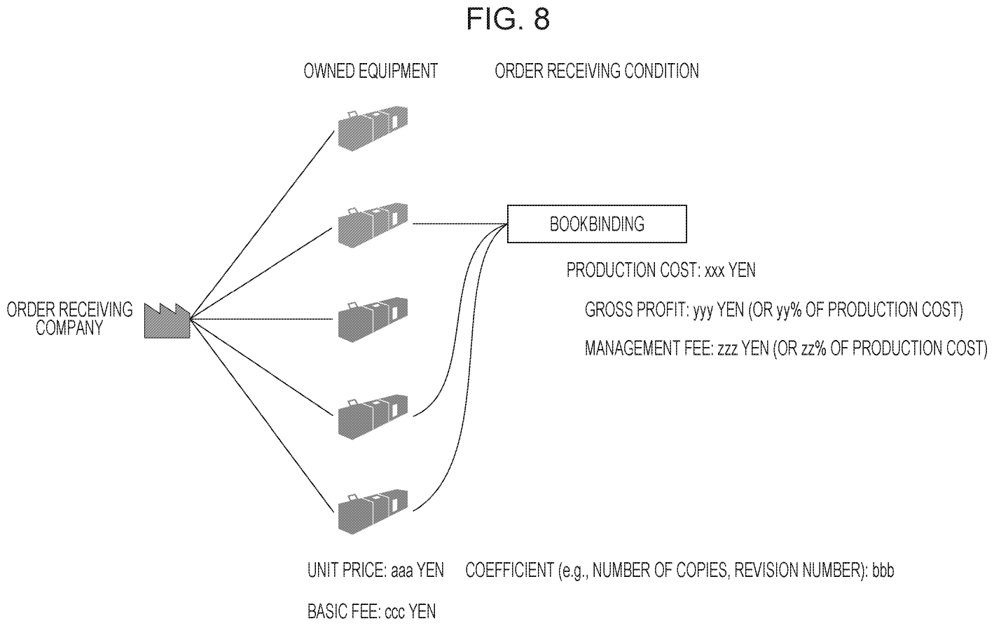

Next, an estimated amount of money to be charged by an order receiving company presented to an ordering company is specifically described with reference to FIG. 8.

FIG. 8 is a view for explaining a method for calculating an estimated amount of money to be charged by an order receiving company presented to an ordering company according to the present exemplary embodiment.

As illustrated in FIG. 8, a production cost of an order receiving company is calculated based on a combination of equipment used for production by the order receiving company. The example of FIG. 8 shows that in a case where a production requirement is “BOOKBINDING”, a printed material is produced by a combination of three pieces of equipment. The order receiving condition acquired from the order receipt DB 18 includes base information on a base for calculation of a production cost, as described above. The base information is information including an equipment unit price, a coefficient, and a basic fee. A cost for a single piece of equipment is calculated as follows: equipment unit price×coefficient+basic fee. The equipment unit price and the basic fee are determined in advance for each equipment. The coefficient is, for example, decided in accordance with contents of an order such as the number of copies and a revision number. A production cost for “BOOKBINDING” is calculated as a sum of costs for the respective pieces of equipment. In the example of FIG. 8, the production cost for “BOOKBINDING” is calculated as a sum of costs for the three pieces of equipment.

The estimated amount of money is calculated based on the production cost. That is, the estimated amount of money is calculated as a production cost+a gross profit+a management fee. The gross profit is a gross profit which the order receiving company is supposed to get. The gross profit may be an amount of money decided in advance for each production requirement or may be an amount of money decided as yy % of the production cost. The management fee is a cost for management needed by the order receiving company. The management fee may be an amount of money decided in advance for each production requirement or may be an amount of money decided as zz % of the production cost. The gross profit and management fee need just be acquired in advance from the order receiving company.

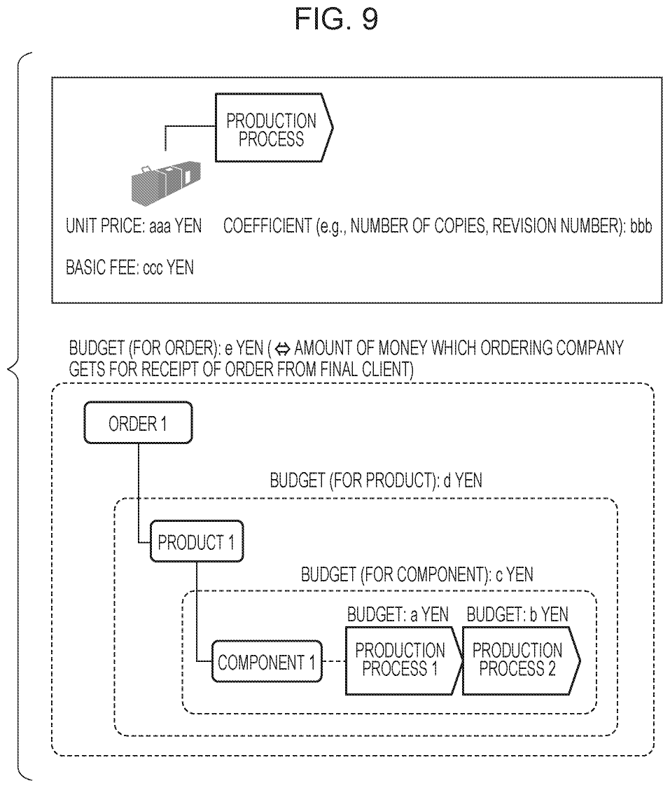

Next, a budget of an ordering company is specifically described with reference to FIG. 9.

FIG. 9 is a view for explaining a method for calculating a budget of an ordering company according to the present exemplary embodiment.

As illustrated in FIG. 9, equipment is associated with a production process. Also in the case of an ordering company, a cost for a single piece of equipment is calculated as follows: equipment unit price×coefficient+basic fee, as in the case of an order receiving company. A production cost is calculated as a sum of costs of respective pieces of equipment. The calculated production cost is a budget of the ordering company. In the example of FIG. 9, “BUDGET: e YEN” is a budget for the whole “ORDER 1” with respect to an amount of money which the ordering company gets for receipt of an order from a final client, “BUDGET: d YEN” is a budget for “PRODUCT 1”, and “BUDGET: c YEN” is a budget for “COMPONENT 1”. Furthermore, “BUDGET: a YEN” is a budget for “PRODUCTION PROCESS 1”, and “BUDGET: b YEN” is a budget for “PRODUCTION PROCESS 2”.

For these budgets and production requirement, the acquisition unit 21A acquires an order receiving condition including base information presented by each order receiving company from the order receipt DB 18. Then, the calculation unit 21B calculates a production cost and an estimated amount of money to be charged from the production requirement and the base information and calculates a profit rate or a profit amount relative to a budget based on the calculated estimated amount of money and the budget. Specifically, the profit rate (%) is expressed by ((budget−estimated amount of money)/budget)×100), and a profit amount (yen) is expressed by (budget−estimated amount of money).

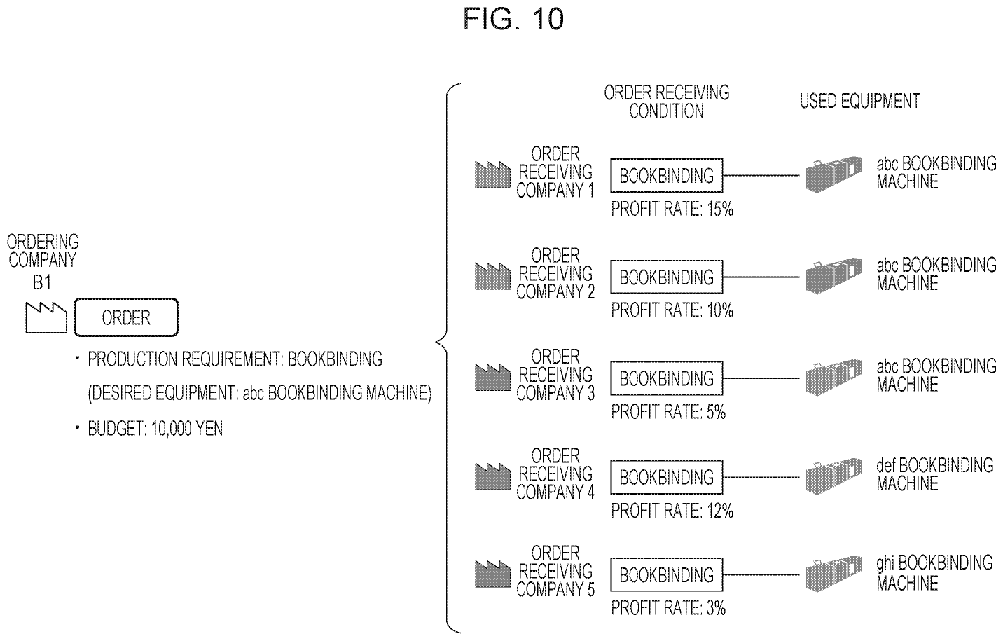

FIG. 10 illustrates an example of a state in which a list of order receiving companies that present order receiving conditions that meet an ordering condition including a single production requirement is displayed in a case where an outsourcing pattern for an ordering company is designated according to the present exemplary embodiment.

The outsourcing pattern illustrated in FIG. 10 is a pattern in which the ordering company Bl outsources a part of “PRODUCTION PROCESS”. An ordering condition for this outsourcing pattern includes, for example, “BOOKBINDING” as a production requirement, “abc BOOKBINDING MACHINE” as desired equipment, and “10,000 YEN” as a budget. On the orderer terminal 4, information on plural order receiving companies (e.g., “ORDER RECEIVING COMPANY 1” to “ORDER RECEIVING COMPANY 5”) that present order receiving conditions that meet this ordering condition and information on profit rates and used equipment of the plural order receiving companies are displayed.

Although plural order receiving companies are displayed for a single outsourcing pattern in the example of FIG. 10, the plural order receiving companies may be displayed in a descending order of a profit rate. Alternatively, an order receiving company that has equipment desired by the ordering company may be displayed preferentially in a displaying order.

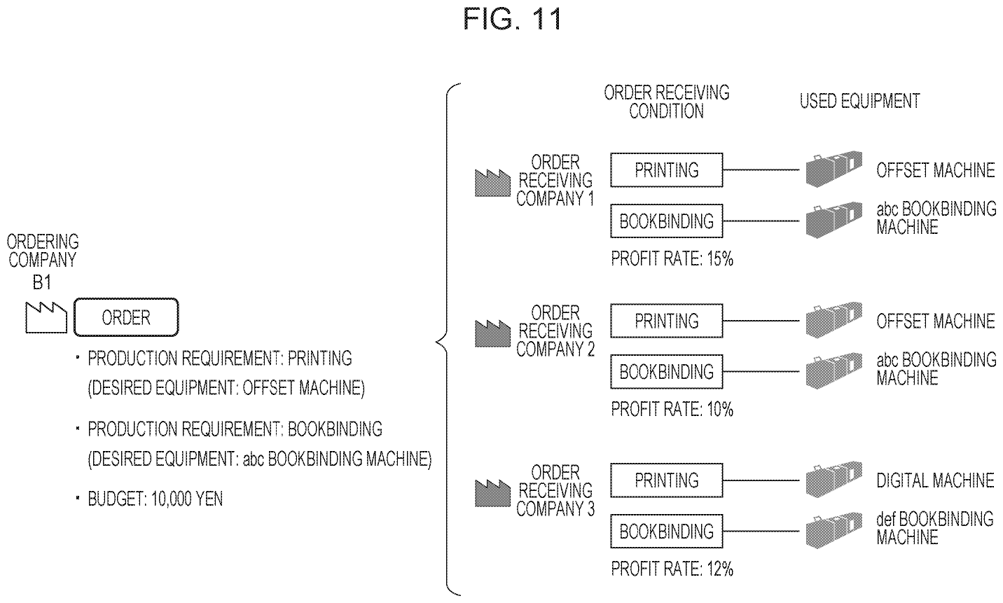

FIG. 11 illustrates an example of a state where a list of order receiving companies that present order receiving conditions that meet an ordering condition including plural production requirements in a case where an outsourcing pattern for an ordering company is designated according to the present exemplary embodiment.

The outsourcing pattern illustrated in FIG. 11 is a pattern in which the ordering company B1 outsources a part of “PRODUCTION PROCESS”. An ordering condition for this outsourcing pattern includes, for example, “PRINTING” as a first production requirement, “OFFSET MACHINE” as desired equipment, “BOOKBINDING” as a second production requirement, “abc BOOKBINDING MACHINE” as desired equipment, and “10,000 YEN” as a budget. On the orderer terminal 4, information on plural order receiving companies (e.g., “ORDER RECEIVING COMPANY 1” to “ORDER RECEIVING COMPANY 3”) that present order receiving conditions meeting this ordering condition and information on profit rates and used equipment of the plural order receiving companies are displayed.

In the example of FIG. 11, plural production requirements “PRINTING” and “BOOKBINDING” are included for each of the plural order receiving companies. Accordingly, a profit rate for “PRINTING” and a profit rate for “BOOKBINDING” are found, and an average profit rate that is an average of these profit rates is displayed. The same applies to a case where three or more production requirements are included.

As in the example of FIG. 10, although plural order receiving companies are displayed for a single outsourcing pattern in the example of FIG. 11, the plural order receiving companies may be displayed in a descending order of a profit rate. Alternatively, an order receiving company having equipment desired by the ordering company may be displayed preferentially in a displaying order.

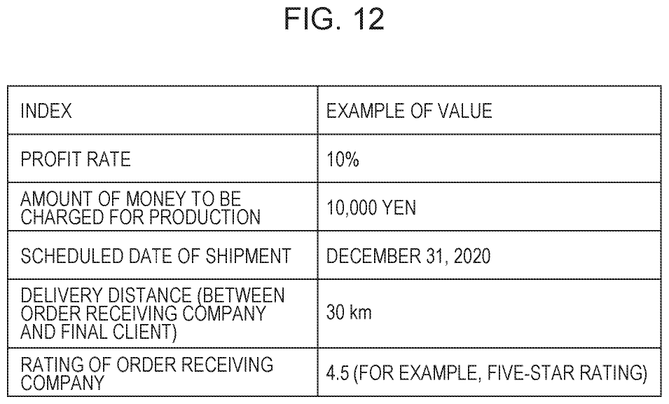

FIG. 12 illustrates an example of comparison index values of an order receiving company presented to an ordering company according to the present exemplary embodiment.

As illustrated in FIG. 12, which illustrates comparison index values of an order receiving company presented to an ordering company, examples of the indices include a profit rate, an amount of money to be charged for production (estimated amount of money to be charged), a scheduled date of shipment, a delivery distance (a distance between the order receiving company and a final client), and rating of the order receiving company. As examples of values of the indices, “10%”, “10,000 YEN”, “Dec. 31, 2020”, “30 km”, and “4.5 (FOR EXAMPLE, FIVE-STAR RATING)” are presented for the profit rate, the amount of money to be charged for production (estimated amount of money to be charged), the scheduled date of shipment, the delivery distance, and the rating of the order receiving company, respectively. The comparison index values are presented for each order receiving company.

FIG. 13 illustrates an example of a state where plural outsourcing patterns are displayed in a comparable manner according to the present exemplary embodiment.

In the example of FIG. 13, the outsourcing patterns P1 to P5 illustrated in FIG. 5 are illustrated. On the orderer terminal 4, information on any of the order receiving companies A11 to A15 and an outsourcing profit rate and an overall profit rate of the ordering company B1 for the any of the order receiving companies A11 to A15 are displayed for each of the outsourcing patterns P1 to P5. That is, the CPU 21 serving as the display control unit 21C performs control for displaying an outsourcing profit rate and an overall profit rate of the ordering company B1 for each of the plural outsourcing patterns P1 to P5. Note that the CPU 21 may be configured not to display the overall profit rate. In this case, only an outsourcing profit rate of the ordering company B1 is displayed for each of the plural outsourcing patterns P1 to P5.

In the example of FIG. 13, the outsourcing profit rate is a profit rate for each outsourcing pattern and means a profit rate relative to a budget, as described above. That is, the outsourcing profit rate means a profit rate of the ordering company B1 for at least a part of an order that is outsourced. The overall profit rate is an example of information on a profit of an ordering company for the whole order received by the ordering company and means a profit rate relative to an amount of money which the ordering company gets for receipt of the whole order. That is, the overall profit rate means a profit rate of the ordering company B1 for the whole order received by the ordering company B1. Note that an outsourcing profit amount may be used instead of the outsourcing profit rate, and an overall profit amount may be used instead of the overall profit rate.

Furthermore, the CPU 21 serving as the display control unit 21C performs control for displaying an order receiving company whose outsourcing profit rate is highest for each of the plural outsourcing patterns P1 to P5. That is, for example, plural order receiving companies that present order receiving conditions meeting the ordering condition are extracted for each of the plural outsourcing patterns P1 to P5, as illustrated in FIG. 10. In the example of FIG. 13, an order receiving company whose outsourcing profit rate is highest among the extracted plural order receiving companies is selectively displayed. Specifically, for the outsourcing pattern P1, the order receiving company A11 is selected as an order receiving company whose outsourcing profit rate is highest. Similarly, for the outsourcing pattern P2, the order receiving company A12 is selected as an order receiving company whose outsourcing profit rate is highest, and for the outsourcing pattern P3, the order receiving company A13 is selected as an order receiving company whose outsourcing profit rate is highest. Furthermore, for the outsourcing pattern P4, the order receiving company A14 is selected as an order receiving company whose outsourcing profit rate is highest, and for the outsourcing pattern P5, the order receiving company A15 is selected as an order receiving company whose outsourcing profit rate is highest.

When a person in charge of the ordering company B1 performs a selecting operation such as a clicking operation on any of the plural outsourcing patterns in FIG. 13, a list of plural order receiving companies that present order receiving conditions meeting an ordering condition for the selected outsourcing pattern may be displayed, for example, as illustrated in FIG. 10 or 11.

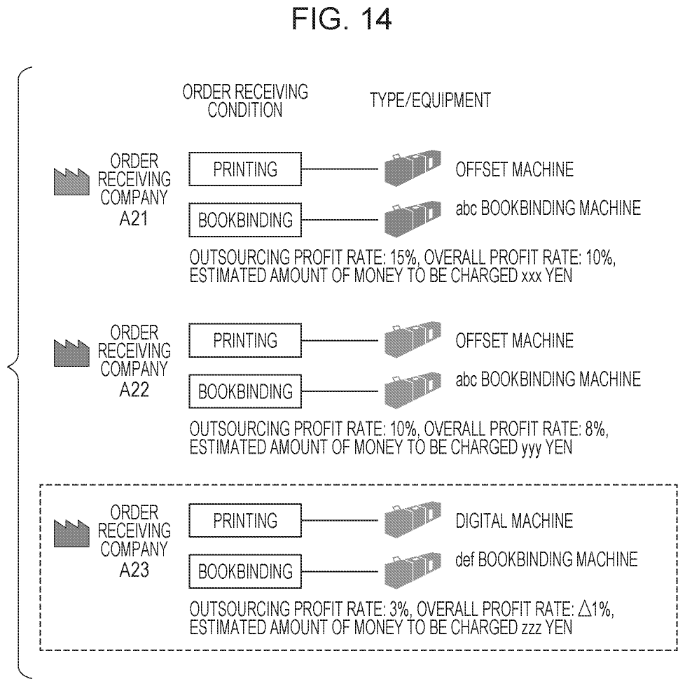

FIG. 14 illustrates an example of a state where a list of order receiving companies is displayed according to the present exemplary embodiment.

The list of order receiving companies illustrated in FIG. 14 is displayed on the orderer terminal 4, for example, when a selecting operation such as a clicking operation is performed on an outsourcing pattern including plural production requirements “PRINTING” and “BOOKBINDING”. The example of FIG. 14 is an example in which a list of order receiving companies for a single outsourcing pattern is displayed. Similarly, for each of the other outsourcing patterns, a list of order receiving companies according to the outsourcing pattern is displayed.

The CPU 21 serving as the display control unit 21C may perform control so that an order receiving company for which an estimated amount of money to be charged is larger than a budget is not displayed or displayed at the bottom of the list for each of the plural outsourcing patterns. For example, in FIG. 14, it is assumed that an estimated amount of money to be charged by the order receiving company A23 is larger than a budget. In this case, the order receiving company A23 is not displayed in the list or displayed at the bottom of the list. Note that the order receiving company A23 may be grayed out.

In a case where an ordering condition includes information on a type (e.g., offset printing, digital printing) of production equipment desired by an ordering company, the CPU 21 serving as the display control unit 21C may perform control for displaying an order receiving company having production equipment of the same type as a type specified by information on the type of production equipment in an emphasized manner for each of the plural outsourcing patterns. For example, in FIG. 14, in a case where a type of production equipment desired by an ordering company is “OFFSET PRINTING”, order receiving companies A21 and A22 having an offset machine that supports “OFFSET PRINTING” are displayed in an emphasized manner. There are various known emphasizing methods such as advancing a displaying order, changing a character color or a background color, giving an underline, using a bold face or an italic face, surrounding with a frame, changing a character size, and changing a font type, and any method can be used as long as the emphasized one is distinguishable.

In a case where the ordering condition further includes information on a model (e.g., abc bookbinding machine, def bookbinding machine) of production equipment desired by the ordering company for each type of production equipment, the CPU 21 serving as the display control unit 21C may perform control for displaying an order receiving company having production equipment of the same model as a model specified by information on the model of production equipment in an emphasized manner for each of the plural outsourcing patterns. For example, in FIG. 14, in a case where a model of production equipment desired by the ordering company is “abc BOOKBINDING MACHINE”, the order receiving companies A21 and A22 having the same “abc BOOKBINDING MACHINE” are displayed in an emphasized manner. An emphasizing method has been already described, and therefore repeated description thereof is omitted.

Furthermore, the CPU 21 serving as the display control unit 21C may perform control so that an order receiving company whose overall profit rate is minus is not displayed or displayed at the bottom of the list for each of the plural outsourcing patterns. For example, in FIG. 14, the overall profit rate of the order receiving company A23 is minus. In this case, the order receiving company A23 is not displayed or displayed at the bottom of the list. Note that the order receiving company A23 may be grayed out.

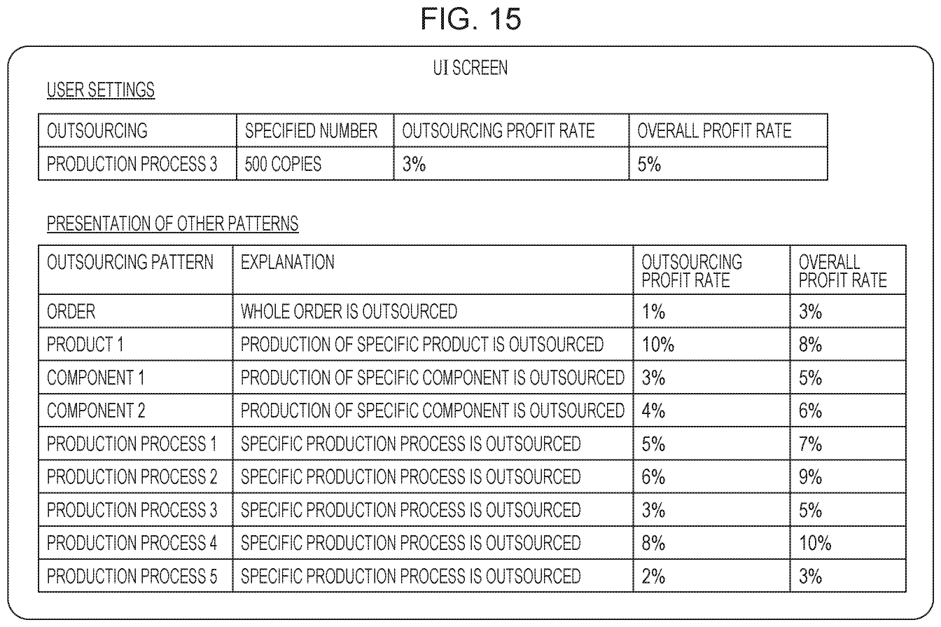

The outsourcing patterns illustrated in FIG. 13 may be displayed, for example, as a user interface (UI) screen illustrated in FIG. 15.

FIG. 15 illustrates an example of a UI screen according to the present exemplary embodiment.

The UI screen illustrated in FIG. 15 is a screen including “USER SETTINGS” and “PRESENTATION OF OTHER PATTERNS” and is displayed on the orderer terminal 4. In the “USER SETTINGS”, an outsourcing pattern which a user is planning to employ is displayed. Specifically, a pattern in which 500 copies out of 1000 copies in “PRODUCTION PROCESS 3” are outsourced is displayed. In this outsourcing pattern, an outsourcing profit rate and an overall profit rate are displayed.

In “PRESENTATION OF OTHER PATTERNS”, an outsourcing profit rate and an overall profit rate are displayed for each of outsourcing patterns “ORDER”, “PRODUCT 1”, “COMPONENT 1”, “COMPONENT 2”, “PRODUCTION PROCESS 1”, “PRODUCTION PROCESS 2”, “PRODUCTION PROCESS 3”, “PRODUCTION PROCESS 4”, and “PRODUCTION PROCESS 5”. These outsourcing patterns are displayed so that a pattern of a higher profit rate can be grasped. For example, values of an order receiving company whose profit rates are highest (for example, an outsourcing profit rate “10%” and an overall profit rate “8%” of “PRODUCT 1”) are displayed as the outsourcing profit rate and the overall profit rate. A color of values of an order receiving company whose profit rates are highest may be changed so that these values are distinguishable. Detailed information such as profit rates and used equipment of plural order receiving companies may be displayed for each outsourcing pattern.

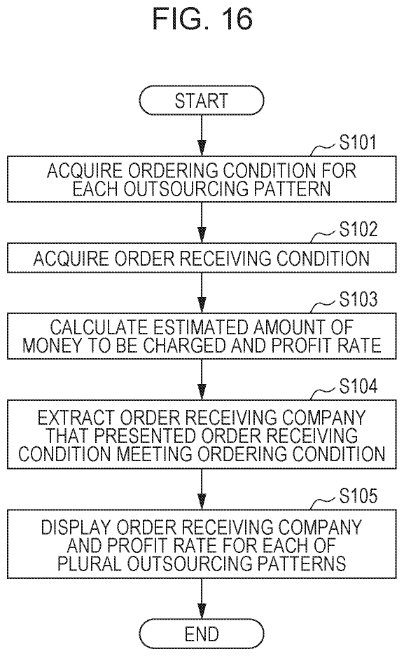

Next, operation of the information processing apparatus 10 according to the present exemplary embodiment is described with reference to FIG. 16.

FIG. 16 is a flowchart illustrating an example of a flow of processing performed by the information processing program 25A according to the present exemplary embodiment.

First, when an instruction to execute outsourcing pattern displaying processing is given to the information processing apparatus 10, the CPU 21 activates the information processing program 25A and executes the following steps.

In step S101 of FIG. 16, the CPU 21 acquires an ordering condition for each outsourcing pattern from the orderer terminal 4 provided in an ordering company in a case where at least a part of an order is outsourced. The ordering condition includes, for example, a production requirement for the outsourced part, a budget, a type of production equipment desired by the ordering company, and a model of the production equipment, as described above. The budget is, for example, an amount of money indicative of a production cost which the ordering company is supposed to bear in a case where the ordering company undertakes production, as illustrated in FIG. 9.

In step S102, the CPU 21 acquires order receiving conditions presented by plural order receiving companies from the order receipt DB 18. The order receiving conditions include, for example, a supported production item, owned equipment, and base information (e.g., an equipment unit price, a coefficient, and a basic fee) that is a base for calculation of a production cost, as described above.

In step S103, the CPU 21 calculates a production cost according to the production requirement and an estimated amount of money to be charged based on the production cost, for example, as illustrated in FIG. 8 by using the production requirement acquired in step S101 and the base information acquired in step S102 and calculates a profit rate (or a profit amount) relative to the budget of the ordering company on the basis of the calculated estimated amount of money and the budget.

In step S104, the CPU 21 extracts an order receiving company that presents an order receiving condition meeting an ordering condition for each of the plural outsourcing patterns, for example, as illustrated in FIG. 10 or 11. For example, the CPU 21 extracts an order receiving company whose profit rate (or profit amount) is highest for each outsourcing pattern.

In step S105, the CPU 21 performs control for displaying, for each of the plural outsourcing patterns, information on the order receiving company extracted in step S104 and the profit rate (or the profit amount) relative to the budget of the ordering company calculated in step S103 on the orderer terminal 4, for example, as illustrated in FIG. 13 and then finishes the series of processing of the information processing program 25A.

As described above, according to the present exemplary embodiment, in a case where control for displaying plural outsourcing patterns for an ordering company that outsources at least a part of an order is performed, information on an order receiving company that is a candidate for an outsourcee and information on a profit which the ordering company is supposed to get when outsourcing the at least part of the order to the order receiving company are displayed for each of plural outsourcing patterns. This allows the ordering company to grasp how much profit the ordering company is supposed to get when outsourcing the at least part of the order to which order receiving company in which outsourcing pattern at a glance.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiments above, and may be changed.

The information processing apparatus according to the exemplary embodiment has been described above. The exemplary embodiment may be realized in the form of programs for causing a computer to execute functions of the units of the information processing apparatus. The exemplary embodiment may be realized in the form of a computer-readable non-transitory recording medium in which these programs are stored.

The configuration of the information processing apparatus described in the above exemplary embodiment is an example and may be changed according to a situation without departing from the spirit.

The flow of processing of the program described in the above exemplary embodiment is also an example, and an unnecessary step may be deleted, a new step may be added, and a processing order may be changed without departing from the spirit.

Although a case where the processing according to the exemplary embodiment is realized by a software configuration by using a computer by executing a program, this is not restrictive. The exemplary embodiment may be realized, for example, by a hardware configuration or a combination of a hardware configuration and a software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising;
a processor configured to:
acquire an ordering condition for each of a plurality of outsourcing patterns from an ordering company that places an order in a case where the ordering company outsources at least a part of the order;
acquire order receiving conditions presented by a plurality of order receiving companies that are candidates for an outsourcee; and
perform control for displaying, for each of the plurality of outsourcing patterns, information on an order receiving company that presents an order receiving condition meeting the ordering condition for the outsourcing pattern and information on a profit which the ordering company is supposed to get when outsourcing the at least the part of the order to the order receiving company.

2. The information processing apparatus according to claim 1, wherein
the ordering condition includes a budget for the at least the part of the order;
the information on the profit is a profit rate or a profit amount relative to the budget; and
the processor is configured to perform control for displaying the plurality of outsourcing patterns for the ordering company so that an order receiving company that is highest in the profit rate or the profit amount relative to the budget is displayed for each of the plurality of outsourcing patterns.

3. The information processing apparatus according to claim 2, wherein
the processor is configured to:
calculate an estimated amount of money to be charged by the order receiving company for the at least the part of the order;
perform control for displaying the plurality of outsourcing patterns for the ordering company so that an order receiving company for which the estimated amount of money is larger than the budget is not displayed or displayed at a bottom of a list for each of the plurality of outsourcing patterns.

4. The information processing apparatus according to claim 1, wherein
the ordering condition includes information on a type of production device desired by the ordering company; and
the processor is configured to perform control for displaying the plurality of outsourcing patterns for the ordering company so that an order receiving company having a production device of a same type as a type specified by information on the type of the production device is displayed in an emphasized manner for each of the plurality of outsourcing patterns.

5. The information processing apparatus according to claim 4, wherein
the ordering condition further includes information on a model of the production device desired by the ordering company for each type of the production device; and
the processor is configured to perform control for displaying the plurality of outsourcing patterns for the ordering company so that an order receiving company having a production device of a same model as a model specified by information on the model of the production device is displayed in an emphasized manner for each of the plurality of outsourcing patterns.

6. The information processing apparatus according to claim 1, wherein
the processor is configured to perform control for displaying the plurality of outsourcing patterns for the ordering company so that information on a profit which the ordering company is supposed to get for the at least the part of the order to be outsourced and information on a profit which the ordering company is supposed to get for the whole order received by the ordering company are displayed for each of the plurality of outsourcing patterns.

7. The information processing apparatus according to claim 6, wherein
the information on the profit which the ordering company is supposed to get for the whole order is a profit rate or a profit amount relative to an amount of money which the ordering company gets for receipt of the whole order; and
the processor is configured to perform control for displaying the plurality of outsourcing patterns for the ordering company so that an order receiving company for which the profit rate or the profit amount relative to the amount of money which the ordering company gets for receipt of the whole order is minus is not displayed or displayed at a bottom of a list for each of the plurality of outsourcing patterns.

8. The information processing apparatus according to claim 1, wherein
the ordering condition includes a production requirement and a budget for the at least the part of the order;
the order receiving conditions include base information, which is information on a base for calculation of a production cost; and
the processor is configured to calculate a production cost according to the production requirement and an estimated amount of money to be charged based on the production cost by using the production requirement and the base information and calculates, as the information on the profit which the ordering company is supposed to get, a profit rate or a profit amount relative to the budget based on the calculated estimated amount of money and the budget.

9. The information processing apparatus according to claim 8, wherein
the budget is an amount of money indicative of a production cost which the ordering company is supposed to bear in a case where the ordering company undertakes production.

10. A non-transitory computer readable medium storing a program causing a computer to execute a process for information processing, the process comprising:
acquiring an ordering condition for each of a plurality of outsourcing patterns from an ordering company that places an order in a case where the ordering company outsources at least a part of the order;
acquiring order receiving conditions presented by a plurality of order receiving companies that are candidates for an outsourcee; and
performing control for displaying, for each of the plurality of outsourcing patterns, information on an order receiving company that presents an order receiving condition meeting the ordering condition for the outsourcing pattern and information on a profit which the ordering company is supposed to get when outsourcing the at least the part of the order to the order receiving company.

11. An information processing apparatus comprising:
means for acquiring an ordering condition for each of a plurality of outsourcing patterns from an ordering company that places an order in a case where the ordering company outsources at least a part of the order;
means for acquiring order receiving conditions presented by a plurality of order receiving companies that are candidates for an outsourcee; and
means for performing control for displaying, for each of the plurality of outsourcing patterns, information on an order receiving company that presents an order receiving condition meeting the ordering condition for the outsourcing pattern and information on a profit which the ordering company is supposed to get when outsourcing the at least the part of the order to the order receiving company.
